(19) United States
(12) Patent Application Publication
(10) Pub. No.: US 2014/0074520 A1
(43) Pub. Date: Mar. 13, 2014

(54) Rich Service Systems with Customized Content

(71) Applicant: Kerry Raymond Hicks, Evergreen, CO (US)

(72) Inventor: Kerry Raymond Hicks, Evergreen, CO (US)

(21) Appl. No.: 13/612,480

(22) Filed: Sep. 12, 2012

(51) Int. Cl. G06Q 10/02

(52) U.S. Cl. 705/5

(57) ABSTRACT

Systems and methods for providing experiential information to a client in a computer networked environment. Compiling experiential information relating to a plurality of “rentable” objects associated with a service provider, e.g., hotel rooms, restaurant tables, cruise ship vacations, event invitations, or the like is contemplated. Following compilation, clients request the information based on specific reservations and the rich content is provided. Establishing a two-way communication between the service provider and the client, which includes a previous step wherein the client provides contact information to the service provider, is also contemplated. In such a case, the service provider may receive updates from the client regarding the reservation and, in response, send different experiential information to the client.

### BACKGROUND

Computer networked systems, such as the Internet as one example, provide a platform for consumers to make reservations, event organizers to invite people to events, and invitees to accept invitations. Online reservation and event coordination systems using the Internet offer some conveniences to users of these systems, such as providing access to basic information regarding location, time, and date. Even with access to basic information, however, the difference between user's expectations at the time of booking a service or responding to an invitation and the user's experiences during the service or event often cause disappointment.

It is with respect to these and other considerations that the present disclosure has been made. Although specific problems have been addressed in this Background, the disclosure is not intended in anyway to be limited to solving those specific problems.

### SUMMARY

Embodiments of the present invention generally relate to systems and methods for providing experiential information to a client. Embodiments work in computer networked environments and provide rich experiential content to potential consumers/clients based on potential or upcoming reservations. Aspects of certain embodiments involve compiling experiential information relating to a plurality of objects associated with a service provider, wherein the objects are available to the client for reservation. The objects may, for example, relate to hotel rooms, restaurant tables, cruise ship vacations, event invitations, or the like. After the information is compiled, embodiments involve receiving a request for information relating to one or more objects; determining that experiential information should be provided; and delivering experiential information the client. Particular embodiments may involve the client making a reservation then requesting specific experiential information on the reserved object.

Aspects of other embodiments of the present invention relate to establishing a two-way communication between the service provider and the client, which includes a previous step wherein the client provides contact information to the service provider. In such a case, the service provider may receive updates from the client regarding the reservation and, in response, send different experiential information to the client.

Aspects of other embodiments relate to objects representing invitations to events. In such cases, the event host is the service provider and the invitees are the clients. In response to receiving an invite acceptance and contact information from the invitee, embodiments of the invention may associate the consumer with a particular property, such as food item to bring to the event. Next, in some embodiments, the invite may cancel or send an update essentially declining of the invitation. When this occurs, embodiments of the invention may automatically associate a different invitee with the particular property and alerting the different invitee, essentially making sure the item requested item is handled. In some situations the invitation and or the properties may be modified by the invitees.

### BRIEF DESCRIPTION OF THE DRAWINGS

FIG. 1 illustrates a computer system for implementing embodiments of methods and systems disclosed herein.

FIG. 2 represents a logical representation of a network environment incorporating at least one computer system shown in FIG. 1, the environment providing users with rich experiential information.

FIG. 3 illustrates the interaction between software modules that may be used in embodiments of the present invention.

FIG. 4 is a flow diagram illustrating operational characteristics of establishing a session with a potential user according to embodiments of the present invention.

FIG. 5 is a flow diagram illustrating operational characteristics of providing consumer with experiential information in relation to a reservation request system according to embodiments of the present invention.

FIG. 6 is a flow diagram illustrating operational characteristics of providing consumer with experiential information in relation to a service or event invitation/reservation system for providing a user with experiential information.

### DETAILED DESCRIPTION

This disclosure will now more fully describe exemplary embodiments with reference to the accompanying drawings, in which some of the possible embodiments are shown. Other aspects, however, may be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art.

This disclosure includes embodiments of systems and methods for providing consumers and invitees with experiential information when reserving services or responding to invitations. Experiential information is information that closely replicates or indicates what an individual would perceive through one or more of his or her five senses while physically present at a location.

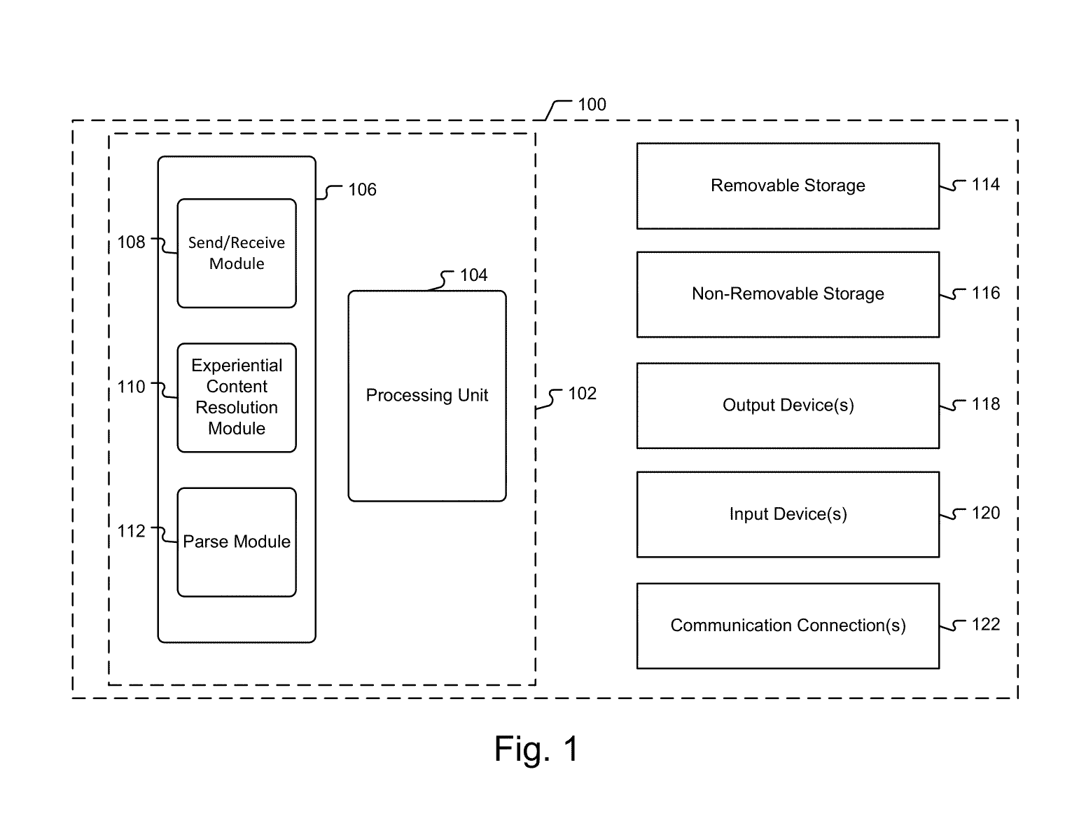

FIG. 1 illustrates a computing environment 100 for implementing the various embodiments described herein. Any and all components of the described embodiments may execute as or on a client computer system, a server computer system, a combination of client and server systems, a handheld device, and other possible computing environments or systems described herein. As such, this disclosure describes a basic computer system applicable to these environments.

Dashed line 102 illustrates the most basic configuration of computer system 100. The most basic computer system 102 comprises at least one processing unit or processor 104 and system memory 106. Depending on the exact configuration and type of computer system 100, system memory 106 may be volatile (such as RAM), non-volatile (such as ROM, flash memory, etc.) or some combination of the two. In some embodiments, one or more logical operations of the described system are loaded into the system memory 106. This may include, for example, a send/receive module 108, an experience content resolution module 110, and a parse module 112.

Additionally, computer system 100 may have additional features/functionality. For example, computer system 100 includes additional storage media for storing experiential information including videos, images, and text. Such additional storage (removable and/or non-removable) includes, but is not limited to, magnetic or optical disks or tapes, and/or other tangible storage devices. FIG. 1 illustrates removable storage 114 and non-removable storage 116. Computer storage media includes volatile and nonvolatile, removable and non-removable media implemented in a method or technology for storage such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by system 100.

System 100 may contain other devices. For example, system 100 may contain output device(s) 118 and may include monitors, displays, speakers, printers, etc. Additionally, system 100 may contain input device(s) 120 such as keyboard, mouse, pen, voice input device, touch input device, etc., for entering data and information, such as information used to evaluate a request for experiential information. System 100 may include communication connection(s) 122 that allow the device to communicate with other devices. These devices are known in the art and need not be discussed at length.

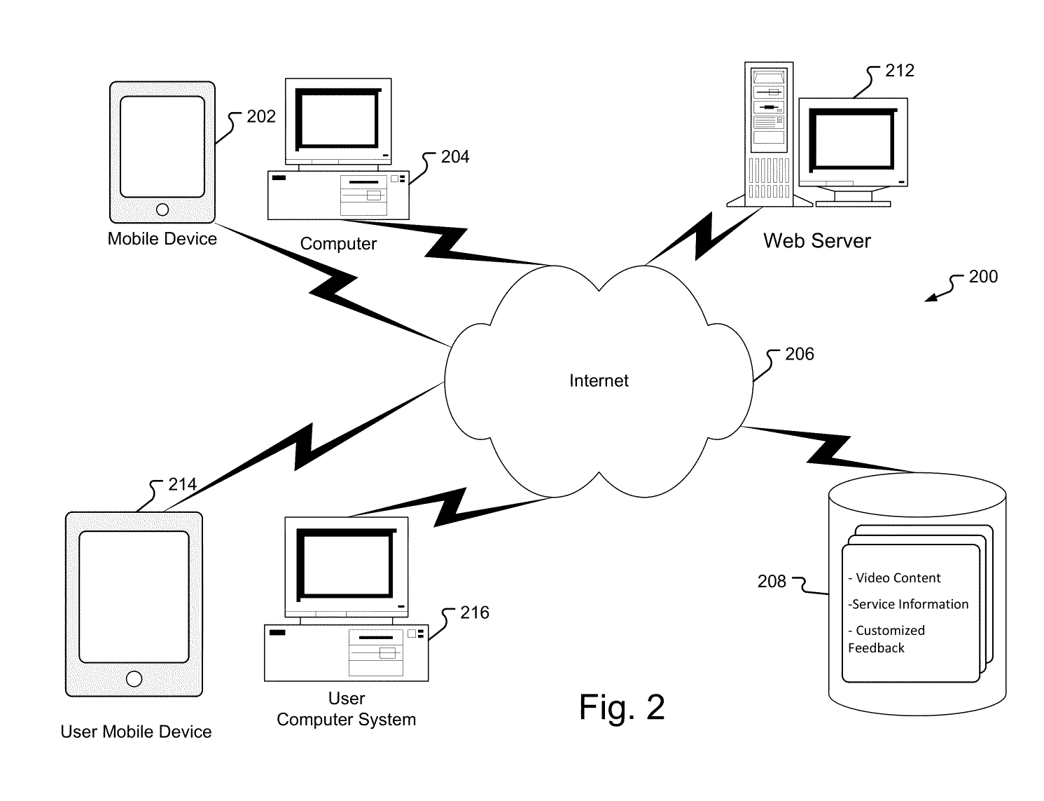

FIG. 2 illustrates a network environment 200 that may provide a potential platform for users and service providers to share and obtain experiential information, such as video content and/or other content. A user is a person, group, business, organization, or sovereign that seeks to provide and/or receive experiential information. Embodiments may include network environments that allow a user to provide and/or receive experiential information when using online reservation systems to book a room at a hotel or a table at a restaurant. Other embodiments may include a network environment that allows users to provide and/or receive information regarding an event.

With respect to a service provider's reservation system, in an embodiment, the network environment 200 may allow service providers to provide experiential information which customers may find useful and compelling. For example, the service provider may be a hotel, restaurant, cruise ship, theater or other service provider that takes reservations for rooms, seats, tables, etc. and these service providers may look to use network 200 to provide experiential information to a potential user, e.g., a potential patron. In another embodiment the network environment 200 may be configured such that previous customers may provide experiential information to the service provider to enrich the experiential information, essentially dynamically updating the content.

For example, in an embodiment, a service provider may use a mobile device 202 or a computer 204 to upload information through a communication network 206 (hereinafter, “network”) to a database 208. In some embodiments, the webserver is coupled to a database 208 through an internal network. In embodiments, a hotel manager or restaurant owner may have generated the information for purposes of upload. Alternatively, a previous customer may use a mobile device 202 or a computer 204 to upload information she personally generated. As discussed above with respect to FIG. 1, in embodiments, the mobile device 202 may be a mobile phone, a tablet, or another hand-held device, and/or a car navigation/entertainment communication system and the computer 204 may be a personal computer, a computer terminal, or a smart terminal or other computer system.

In some embodiments, the user may not only provide updated content that can be used by the service provider to deliver better, more accurate information to future users, but the user may essentially simply provide contact information for the service provider to later contact the user. Such an embodiment is particularly useful in embodiments where the reservation may have some variables associated with it. For example, a guest of a restaurant may get updated menu information before the reservation. In another embodiment, the user may receive updates on when the table will be ready. The user has essentially created a direct connection to the service provider setting up a two-way communication for both giving information to the service provider and for receiving information from the service provider.

In embodiments, a database 208 is used to store experiential information. The experiential information is preferably stored in the form of objects, where the objects relate to the rentable or reservable items, e.g., hotel rooms, restaurant tables, and the like. Those skilled in the art may appreciate other acceptable methods of storing and structuring the data in database 208. In an embodiment, database 208 may index information of objects based on descriptors such as general categories, unique categories, and specific instances. These descriptors may follow a hierarchical structure, and this hierarchical structure may be used to index information to the object. For example, specific instances may be a subgroup of the group unique categories, and unique categories may be a group for the super-group general categories.

Consider, for example, the service provider of a hotel. A particular room may be considered an object. This particular room may be under a general category of rooms for rent. A unique category may be suites. Following a hierarchical structure, a particular room that was categorized as a suite would index to all information associated with suites, and would further index to all information associated with rooms for rent. A particular room would additionally have specific instances of information associated with that room and only that room. For example, the view may be specific to that room and, moreover, some views may change with the seasons given potential tree foliage. In other embodiments, a specific room may have certain attributes that are not associated with all information associated with suites. For instance, “suites” may have secondary sleeping areas as a general rule in a particular hotel. That said however, if the hotel has a room that does not have a secondary sleeping and instead has a pull-out couch but otherwise is categorized as a suite, then that room may index to all the attributes of the other suites, except for the secondary sleeping area attribute. The database can provide for this sort of “negative attribute.” In essence, the database may be configured to index only those pieces of information associated with each specific room as those skilled in the art will appreciate.

Another embodiment may be a network environment 200 for a restaurant. A particular table may be under a general category of tables available for reservation. A unique category associated with some tables in the restaurant may be patio seating. Following a hierarchical structure, a particular table that was categorized as patio seating would index to all information associated with patio seating, and would further index to all information associated with tables for reservation. A particular table may have additional specific instances of information associated with the table and only that table. As will be appreciated, these attributes for the different tables may change based on the seasons and/or other reasons. For example, patio seats may have outdoor heaters in the colder seasons, but umbrellas for shade in the warmer seasons. Also, the views may differ. Also, table attributes may be tied to particular wait staff so potential patrons can plan to sit where familiar waiters can help them.

In embodiments, the uploaded information may include experiential information 210 such as audio-visual content associated with a specific instance. For example, in the case of a hotel, the experiential information 210 may include a brief audio-visual tutorial from a member of the hotel-staff regarding amenities for the business traveler. Those amenities may include wireless internet, and the experiential information 210 may further include information regarding how a potential guest may access the wireless internet. Still, in other embodiments, this experiential information may include video of the view from a specific room available for reservation, occupancy status of rooms surrounding the room available for reservation, and video from within the room available for reservation. In other embodiments, the potential guest may access experiential information after she has reserved a room. For example, a business guest may receive guidance on how to obtain internet access while in the specific room she has reserved. Other embodiments may include, but are not limited to other types of information such as information related to floor levels, classes of rooms, floor plans, balconies, views, etc.

In other embodiments, the uploaded audio-visual information may be experiential information 208 associated with a specific restaurant table. This may be, for example, an audio clip of ambient noise previously recorded during a typical dining night. Or it may be a video demonstrating the view of the table from the perspective of one or more seats. In another embodiment, it may be a video from a sommelier educating the potential guest on the topic of different wines available for purchase during the reservation. This may include a video of the sommelier pouring the wine while noting typical wine features such as color, body, smell, and taste.

The transmission of the experiential information may be facilitated through a webserver 212. In embodiments, this webserver may be managed by the service provider. A company may use the webserver to transmit and organize information stored on the database 208 so as to attract customers. In other embodiments, a third party may manage the webserver 212. This third-party manager may use the webserver to transmit and organize information stored on database 208 in such a way that outside reviews, i.e., reviews provided by those not associated with the service provider/company, can be accessed and provided to potential patrons.

In embodiments, a potential customer accesses experiential information 208 using a client-side device, such as user mobile device 214 or a user computer 216. In embodiments, the access may occur using a web browser that runs on the client-side device. In embodiments, access to experiential information may occur by the web browser navigating to a website maintained by the service provider. This may be the service provider's commercial website. In other embodiments, access may occur by a web browser navigating to a website maintained by a third party. This may be, for example, a travel site providing recommendations regarding hotels and restaurants. Alternatively, in other embodiments, the interaction may be a web-based and mobile-based technology designed to allow organizations, individuals, and groups to interact and communicate with each other via user-generated content.

In other embodiments, the user may communicate with the restaurant or other service provider by providing information helpful to the service provider such that the service provider can better provide a good experience. Such information may relate to updates as to whether the user is running late, information as to whether there are more or fewer people in the user's party and/or alert them to the fact that someone in the party has allergies, etc. Moreover, and importantly, the service provider can provide updates to the user such as whether the table has been held up by a slower, previous party, and therefore provide the ability/flexibility to the user to show up later, closer to the actual time in which they will be seated. Upgraded table information along with seating times can also be provided ahead of time to the user. Moreover, the menu and other information that user may want to review ahead of the actual dinner may be pushed out to the user as well.

As may be appreciated, many variations of the two-way communication regarding an actual reservation may be achieved through this system. Moreover, the system can automatically send and receive the information such that no phone calls are needed between the service provider and the user.

Another embodiment involves an event coordination system. In such an embodiment, network environment 200 provides an event organizer an opportunity to deliver information to an event invitee. It may also allow the event invitee to provide information back to the event organizer. Exemplary events include fundraising events, birthday parties, organized protests, among other potential events.

For instance, in an embodiment, an event organizer may use a client side device, such as mobile device 202 or computer 204 to upload information through a communication network 206 to database 208. In some embodiments, the webserver is coupled to database 208 through an internal network. In embodiments, an event organizer may have generated the information for purposes of upload. The mobile device 202 may be a mobile phone, a tablet, or another hand-held device, and the computer 204 may be a personal computer, a computer terminal, or a smart terminal.

In embodiments, database 208 may index information through relations between and among event organizers, event invitees, and other objects. For example, an event organizer might invite people to a birthday party using the system 200. The event organizer may wish to have each invitee volunteer to bring a food item. Certain information may be associated with each food item, such as suggested recipes and yield requirements. Using a user mobile device 214 or a user computer 216, an event invitee may communicate that he or she would like to volunteer to bring a food item. The database 208 would then be configured in such a way that the invitee and the food item were associated. In embodiments, any information that the invitee uploaded may be associated with food item, the invitee name, the event, or the event organizer as appropriate. In other embodiments, the database may be hierarchical in structure, as will be appreciated by those skilled in the art.

In yet another embodiment, the system 200 provides for dynamically adjusting to changes that occur in the guest list. For instance, should one invitee cancel, the system can provide an alert to the other guests that not only will the canceling party not be able to attend, but that some other guest may need to bring the item that the canceling party was committed to bring.

In embodiments, the uploaded information may include experiential information 210 such as audio-visual content related to objects. For example, in the case of a birthday party, the experiential information 210 may include a brief audio-visual description of the venue or food item requirements. The food item requirements may include a video discussion of dietary restrictions, such as food allergens. This information 210 may be uploaded by the event organizer using a mobile device 202 or a computer 204, or it may be uploaded by an event invitee using a mobile device 214 or a computer 216.

The transmission of this information may be facilitated through a webserver 212. In embodiments, this webserver may be managed by a third party unaffiliated with either the event organizer or the event invitees. This third-party manager may use the webserver to transmit and organize information stored on database 210.

In embodiments, an event invitee may access experiential information 210 using a user mobile device 214 or a user computer 216. In embodiments, the access may occur using a web browser that runs on the user's device. In embodiments, access to experiential information may occur by a web browser navigating to a website maintained by a third-party, such as the third-party's commercial website. This may be, for example, an online invitation system that sends electronic invitations, records and displays the responses of invitees, and reminds invitees of upcoming events. Alternatively, in other embodiments, it may be a web-based and mobile based technology designed to allow organizations, individuals, and groups to interact and communicate with each other via user-generated content.

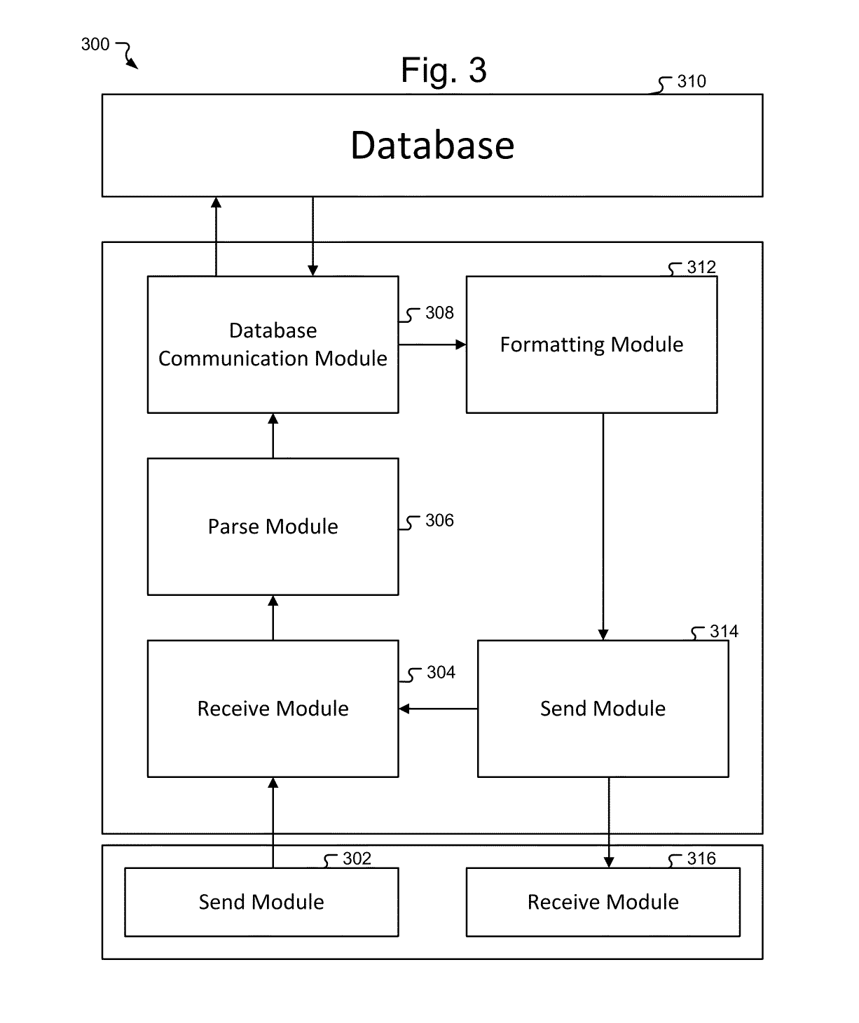

FIG. 3 illustrates the interaction between software modules for an embodiment 300.

In an embodiment, a client-side send module 302 sends a request to a server-side receive module 304 for experiential information. A user may have initiated the request by interacting with a computer terminal, a mobile device, or another computer interface. The request may specify certain experiential information the user may want to access, or the request may just reflect a user's desires to get more information regarding a service or event.

The server-side receive module 304 communicates to the parse module 306 message information. The parse module 306 evaluates the information request and divides the request into its constituent components.

The parse module 306 communicates to the database communication module 308 information sufficient to determine client's experiential request. The database communication model 308 evaluates the information request and determines the appropriate query to make to database 310. After sending a query to the database 310, the database communication module 308 receives the appropriate experiential information from the database 310.

The database communication module 308 sends the experiential information to the formatting module 312. The formatting module 312 then formats the experiential information into an appropriate format for delivery to the client as may be appreciated by those skilled in the art. For instance, when communicating with a mobile phone instead of a desktop, the information may be modified to better fit the mobile phone. Likewise, when communicating with a tablet computer system, the information may be formatted to better fit the tablet computer system.

The formatting module 312 sends the formatted experiential information to the send module 314. The send module 314 sends the formatted experiential information to the client. The formatted information is received by the client-side receive module 316 and presented to the user.

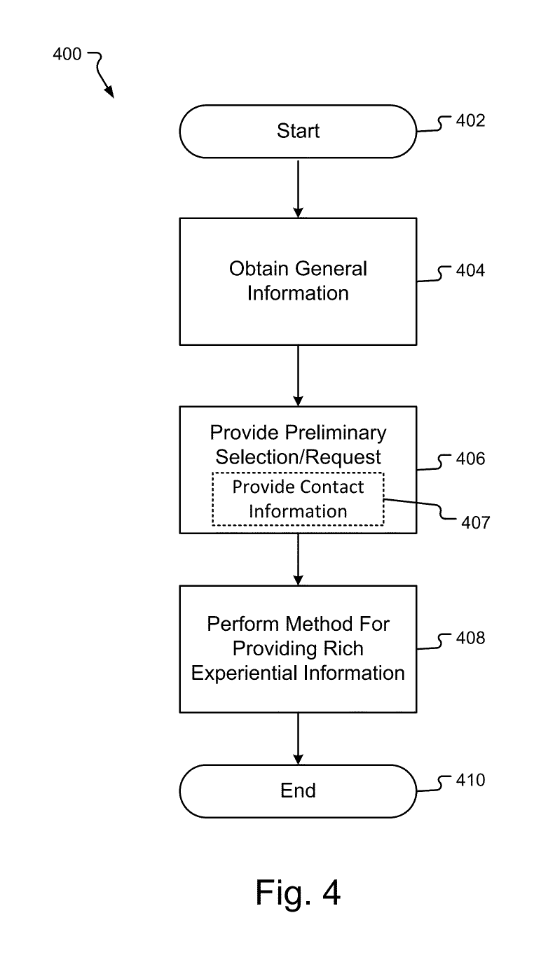

FIG. 4 shows an embodiment of a method 400 for establishing a session with a user to deliver experiential information. As used herein, a session is the connectivity between a service provider and a user such that the service provider can provide, and in some cases, receive experiential information. In embodiments, start operation 402 initiates method 400 when a user navigates to an online reservation or an online event coordination system.

With respect to certain embodiments, the user may be a potential hotel guest. This guest may access a hotel's online reservation system by using network environment, such as a network environment 200 shown in FIG. 2. Files for the online reservation system may be stored in a database 208 and may be served to a client mobile device 214 or the client computer 216 using a web server 206. The potential hotel guest may seek to initiate a session in order to secure a room.

More specifically, and referring to FIG. 4, flow 400 begins at start operation 402, and flows to obtain general information step 404. Obtain general information step 402 relates to the general process step of obtaining, by the client and/or user general information regarding the service or event. In embodiments, a potential hotel guest may review the price and types of rooms available. The potential hotel guest may also obtain other general information such as previous customer reviews, hotel rating, hotel amenities, and location.

Next, flow 400 proceeds to provide preliminary selection/request step 406. The preliminary selection/request operation 406, for the purposes of this application relates to the user initially selecting and/or requesting some specific information beyond what is on the primary page or website and is particular to a specific item, e.g., room details. For instance, the user may be a hotel guest, and the user may select a general room category, such as suite or double room.

In some embodiments, the selection/request operation 406 further includes provide operation 407 which provides user contact information to the service provider. Provide operation 407 is optional and that is why the box is shown in dashed lines. In some embodiments, the provide operation may not occur and in others the provide operation may occur at a different time, e.g., upon receiving some experiential information.

Upon completion of the preliminary selection/request 406 flow proceeds to provide rich experiential information step 408, which represents the process or processes of actually providing the experiential information to the client device.

In an embodiment of the invention, the user may be a potential hotel guest. The provide rich experiential information operation 408, in this example, provides the data to the user to indicate environmental or other experiential conditions for the room and/or hotel.

In another embodiment, the user may be a potential restaurant diner. A potential restaurant diner may initiate start operation 402 by accessing a third party's online reservation system using a web browser through a network, such as the network 206. Files for the online reservation system may be stored in a database, such as a database 208, and may be served to the client mobile device, such as a client mobile device 214, or client computer, such as a client computer 216, using a web server, such as a webserver 212.

In embodiments, general information step 404 is provided by a third-party website. For example, in a restaurant environment, the third party may provide information from previous guests. This embodiment of an online reservation system may not take reservations per se, but may instead allow a guest to survey previous customer content to decide whether to book, for example, a table reservation at a restaurant. In other embodiments, the online reservation system provides such content and enables the taking of reservations as well.

Proceeding with this embodiment, the provide preliminary selection/request step 406 may allow a customer to specify what type of reservation they have or intend to make. For example, a customer having booked a patio table at a restaurant may provide that information in the preliminary response step 406. After the preliminary response step 406 the flow proceeds to move to provide rich experiential information step 408, which provides rich content to the customer so the customer can determine to change the reservation, cancel the reservation, or simply manage expectations.

In yet another embodiment, flow 400 of FIG. 4 involves a user accessing an online event coordination system. Flow 400 would begin at start operation 402 by an invitee accessing files stored on a database 208 through a network 206 facilitated by a webserver 212, all shown in FIG. 2. In an embodiment, this access may begin with the invitee receiving an email with a hyperlink notifying the invitee that she has been invited to an event.

Selecting the hyperlink in that email, in this example, may cause a web browser session to initiate, which would actually initiate general information operation 404. At this operation, the web browser may then receive files from the database, and these files may contain information regarding the appropriate event. Information such as party location, time, date, and theme may be transmitted through the webpage.

Subsequently, the invitee may use a client mobile device or a client computer to perform the provide preliminary selection/request operation 406. This preliminary response may include information that conveys an intention to attend the event, the number of additional guests an invitee may bring, and the invitees preliminary thoughts regarding the event. After the preliminary response step 406 the flow proceeds to provide rich experiential information step 408, which provides the rich content to the user.

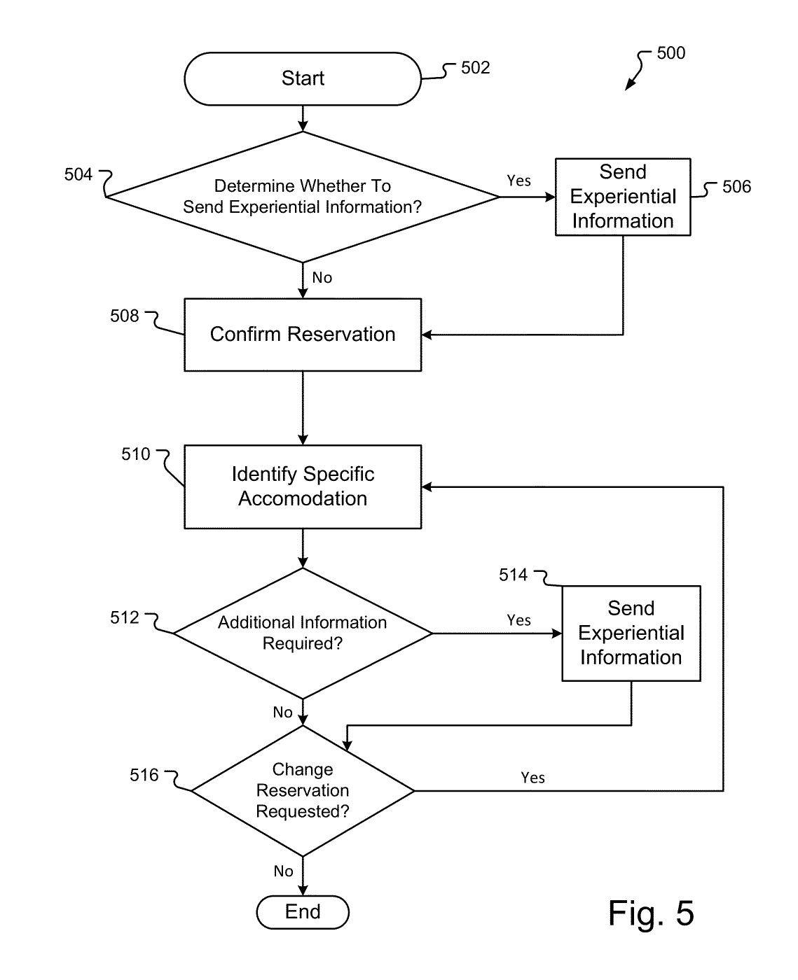

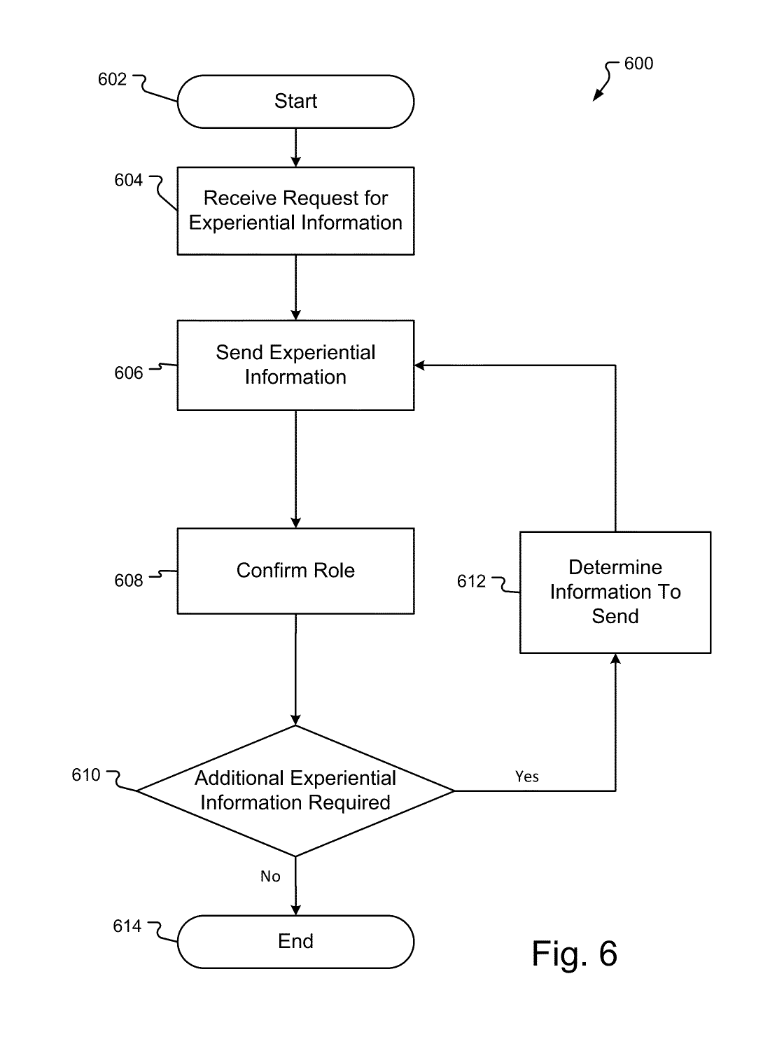

Various examples have been provided above in conjunction with FIG. 4. More details of these and other examples, with respect to the providing of rich experiential information operation 408 are discussed in more detail below in conjunction with FIGS. 5 and 6.

FIG. 5 illustrates an embodiment of method 500 for responding to a potential request for experiential information. Start operation 502 may initiate after a potential consumer has proceeded through method 400. In embodiments, the consumer may be a potential hotel guest or diner. In other embodiments, the consumer or user may be looking to book a trip on a cruise, book a ticket on an airplane, or buy a ticket to a movie. Those skilled in the art will appreciate that other consumers may also utilize this information.

From start operation 502, the operation of method 500 proceeds to determine operation 504. In embodiments, the determine operation 504 determines whether to send the potential consumer experiential information. As discussed above, the experiential information may take many forms, including audio, video, text, etc.

In embodiments, determination operation 504 considers whether the consumer has requested more information. For example, a potential hotel guest that has sent a request for additional information regarding the layout of a general category of room will trigger determination operation 504 to determine that experiential information should be sent to the consumer. In this instance, flow proceeds Yes to send experiential information operation 506.

At send experiential information operation 506, appropriate experiential information may be sent to the consumer. For example, the selection of experiential information may depend on the preliminary response information the consumer may have sent, for example, at step 406 shown in FIG. 4. The experiential information may be a video of an exemplar within a category. This may correspond to the expressed interest of the consumer determined from a preliminary response. This video might be a walk through from the point of view of a hotel guest.

In embodiments, after send experiential information step 506, or if no experiential information needs to be sent, flow continues to confirm reservation step 508. In embodiments, a hotel guest may confirm that she wants to reserve a room in the particular category of rooms. For example, the guest may indicate that she wants a suite. The confirmation may be made by a hotel guest or other consumer using a webpage that communicates with the webserver, such as webserver 212 shown in FIG. 2. In other embodiments, a different webserver may be used. Still other embodiments may include telephonic or in person confirmation. The confirm reservation step 508 is accomplished by obtaining information sufficient to ascertain that the consumer has confirmed a reservation for a service or event.

In accordance with embodiments of the invention, during the confirm reservation operation 508 (or at some other appropriate time), the user/consumer provides contact information, in the form of an email address, a telephone number, a number that receives text messages, or the like. This information is stored, even if just temporarily, e.g., until completion of the reservation, to enable the server system to contact and further provide experiential information to the user/consumer as needed.

Upon completion of the confirm reservation step 508, flow continues to identify specific accommodation step 510. In embodiments, the accommodation may be a hotel room. The hotel company may assign a specific room to the reservation.

The process then continues to query operation 512, wherein query operation 512 determines whether the user requires additional information with respect to the service. Information sufficient to make this determination may come from a webpage. For example, at a confirmation webpage a hotel may query the hotel guest whether they would like to view the assigned room. Alternatively, the webpage may ask whether the consumer would like to review a video on how to set up internet access. Additionally, the hotel manager or owner may decide that this particular guest requires a personalized message. In such an embodiment, the personalized message may begin to play at step 514. For example, a VIP quest that was assigned a penthouse suite may receive a personal thank you from the hotel manager.

In accordance with embodiments of the invention, where the user has provided contact information (e.g., at provide operation 407 FIG. 4), since the user/consumer has provided contact information to the server system, operations 512 and 514 may occur up to and through the completion of the reservation as information is needed to be sent to the user/consumer. For instance, the server system may want to alert the user that their hotel room is ready for an early arrival, or that their room is not going to be ready until a later time. In the latter case, the system may further provide updates as to when the room will be ready so the user/consumer does not have to wait in the lobby, but can otherwise plan accordingly. In such cases, operation 512 and 514 will simply determine the need to send more information and send the same. In some cases, the user may provide some feedback, which may cause more information to be sent. E.g., the user may decide to change the reservation based on the newly received information and flow would branch to change operation 516.

Once the experiential information has been delivered to the user at 514, or if no information is required, flow continues to query operation 516, wherein query 516 determines whether the user would like to change, alter, or add to their existing reservation. With respect to query operation 516, and continuing the above hotel example, the consumer may want to upgrade to room with a better view. If the consumer would like to change, alter, or add to her existing reservation, the process loops back to identify specific accommodation 510. In accordance with other embodiments of the invention, the company providing experiential information may offer the consumer the opportunity to receive additional experiential information after changing the reservation. This may further allow the consumer to make changes. The loop may continue until the consumer does not require a change to the existing reservation.

In other embodiments, the method of FIG. 5 may be used by a third party to send experiential information to a potential restaurant guest. For example, flow may begin at step 502 start operation. A potential diner may have provided information regarding a restaurant reservation at a previous time, such as step 406 or 407 shown in FIG. 4. From here, the third party may determine whether it has relevant information to send to the user based on the previous information provided. For example, a third party may have a video that reviews the food for a particular restaurant. If so, it may send the video to the potential diner at step 506.

Flow then proceeds to confirm reservation step 508. Continuing with the above example, the diner may convey information sufficient for the third party to determine that the diner has made an actual reservation at the restaurant. At identify specific accommodation 510, the diner may indicate that it has a specific table reserved. For example, the table may be a chef's table located in the kitchen of a restaurant.

At determination step 512, a determination of whether the diner requires additional information is made. This may be, for example, determined by a third-party website based on the specific accommodation identified in step 510. For example, the third party may send additional experiential information regarding a table located in the kitchen. If necessary, the user may be sent experiential information 514. In embodiments, this may be an audio clip of the ambient noise taken from a previous diner. Or this may be a video taken from the perspective of a person sitting at the table.

From here, flow continues to change reservation step 516. In this embodiment, the third-party may not have the ability to change the reservation per se, but may receive information sufficient to determine that the customer has or would like to change the reservation. For example, a potential diner may indicate that she is not satisfied with her current reservation, and that she would like to change reservation. The transmission of this information may be through a network. At that point, the process would loop back to identify specific accommodation 510 where the diner can input a different specific table.

As discussed above, and in accordance with other embodiments of the invention, since the user/consumer has provided contact information to the server system, operations 512 and 514 may occur up to and through the completion of the restaurant reservation as information is needed to be sent to the user/consumer. In this case for example, the server system may want to alert the user that their table is ready for an early arrival, or that their table is not going to be ready until a later time. In the latter case, the system may further provide updates as to when the table will be ready so the user/consumer does not have to wait in the restaurant, but can otherwise plan accordingly. In such cases, operation 512 and 514 will simply determine the need to send more information and send the same. In some cases, the user may provide some feedback, which may cause more information to be sent. E.g., the user may decide to change the reservation based on the newly received information and flow would branch to change operation 516. Additionally, the restaurant may want to alert the user/guest of other changes such as menu changes, potential wine pairings, etc.

The embodiments discussed above should not be construed to be limited to hotels or restaurants specifically. The methods described may be used for reservations systems targeted at other services, such as theater seat, a rental car, or a sporting event box suite, among others. The method may also be used for event coordination systems. The company managing the Web server may assign the specific reservation, or the company may merely receive communication from another party regarding the specific accommodation reserved.

FIG. 6 illustrates a process 600 for providing experiential information to users. In embodiments, start 602 proceeds to operation 604 when a web server managed by a company receives a request 604 for experiential information from an event invitee. In embodiments, this may initiate from an invitee viewing a web page containing an invitation.

The invitee may then click or select on a hyperlink that initiates send experiential information step 606. The hyperlink may link to a video message previously uploaded by the event organizer Or it may link to a message uploaded by another event invitee. The presence or absence of hyperlink may be determined by a relationship structure as discussed above. Selecting a hyperlink may cause a webserver, such as webserver 212 shown in FIG. 2, to send a digital video file through a network to an invitee's mobile device or to the invitee's computer. In embodiments, the video message may contain a request that people volunteer to bring a food item to the event.

Following send experiential information step 606, flow proceeds to confirm role 608. In embodiments, the confirmation may be made by an invitee affirming their intention to attend the event by communicating with a webserver. In other embodiments, a different webserver may be used. Still other embodiments may include telephonic or in person reservations. In embodiments, the confirm role step 608 is accomplished by obtaining information sufficient to ascertain that the user has communicated information sufficient to determine whether an invitee will attend the event, and what role (such as guest, keynote speaker, food provider) the invitee will play. For example, at 608 a guest may indicate that that she will bring the dessert to a party.

Following confirmation role operation 608, determine operation 610 determines whether additional experiential information is required. This determination might occur based on the information received in step 608. For example, the event organizer may determine that invitees with certain relationships need to receive special information. Alternatively, an invitee may wish to browse experiential information associated with a party.

If it is determined that no additional experiential information should be sent then flow ends at end operation 614. On the other hand, if determination operation 610 determines that more experiential information is required then flow branches Yes to determine operation 612. The selection of what experiential information gets sent occurs at step 612. In embodiments, the selection may be based on information received in step 608. For example, an invitee that confirmed that it would bring dessert to a party may need to review a video of the cooking accommodations available at the event. Or the video may be a special message from the event organizer reminding the person of certain allergen concerns. In other embodiments, the invitee may select specific files to view. In embodiments, the invitee may access additional experiential information relevant only to those people who intend on attending an event.

If the invitee requires additional experiential information, flow loops to send experiential information 606. In embodiments, the video or experiential content itself may have been uploaded to database 208 using the network 206 by the organizer This may have been accomplished using the organizer's mobile device 202 or the organizer's computer 204. Alternatively, a third party may have created a video or other experiential information as necessary.

In particular embodiments, additional information may be required, as determined by determine operation 610 wherein the additional information is based on the service provider receiving updated information from the user. For instance, in the example where the event organizer desires to have each invitee bring a food item, and later, receives an update that someone has canceled. In such a case, since the canceling party is associated with a particular food item, the system may alert the organizer that someone else needs to bring the food item, and/or the system 200 may alert another invitee to bring the food item. Determine operation 612 handles the determination as to which invitee should bring the food item. Since users have provided their contact information, the system 200 is able to reach out and automatically request that other parties either bring the food item and/or solicit volunteers to bring the food item.

Having described the embodiments of the present invention with reference to the figures above, it should be appreciated that numerous modifications may be made to the present invention that will readily suggest themselves to those skilled in the art and which are encompassed in the spirit of the invention disclosed and as defined in the appended claims. Indeed, while presently preferred embodiments have been described for purposes of this disclosure, various changes and modifications may be made which are well within the scope of the present invention. For example, the present invention may not be limited specifically to reservation systems any systems that users may want/need additional information to appreciate and improve the quality of their experience. As an example, household and business services, e.g., installation, repair and delivery services, may also use such a system to alert and communicate experiential information to the user. To further this example, as merchants track their field personnel, the service provider may interactively send location information, ETA, and service personnel picture/names dynamically through the network 200 to the client device. The user may then, in some cases, send a brief message to the service personnel regarding any service specifics, e.g., gate code, which door to enter, etc. Other embodiments may involve meetings with lawyers or other professionals. Also, once the service has been provided to the customer, the system 200 may be used to provide a video thank you to the user.

Additionally, the order of operations shown in the flow diagrams illustrated in the figures herein is provided for illustrative purposes only and, in accordance with other embodiments, may be modified or performed simultaneously. Furthermore, it should be appreciated that the scope of the present invention accommodates other operations that may be added or removed depending on the needs of the particular entity or entities implementing or using the system.

Similarly, although this disclosure has used language specific to structural features, methodological acts, and computer-readable media containing such acts, it is to be understood that the present invention defined in the appended claims is not necessarily limited to the specific structure, acts, or media described herein. The specific structure, acts, or media are disclosed as exemplary embodiments of implementing the claimed invention. The invention is defined by the appended claims.

What is claimed is:

1. A method of providing experiential information to a client, said method comprising:
compiling experiential information relating to a plurality of objects associated with a service provider, wherein the objects are available to the client for reservation;
receiving a request for information relating to one or more objects;
determining that experiential information should be provided; and
delivering experiential information to the client.

2. The method as defined in claim 1 wherein the client has made a reservation and wherein the experiential information is specific to the reserved object.

3. The method as defined in claim 2 wherein the object comprises one of a hotel room, a cruise ship vacation, a restaurant table, or an invitation to an event.

4. The method as defined in claim 1 further comprising:
receiving contact information from the client; and
establishing a two-way communication between the service provider and the client.

5. The method of claim 4 further comprising:
receiving updates from the client regarding the reservation; and
sending different experiential information to the client in response to receiving the updates from the client.

6. The method of claim 1 wherein the objects are invitations to events and the client is an invitee, wherein the method further comprises:
receiving an invite acceptance and contact information from the invitee;
associating the invitee with a particular property;
receiving an update from the invitee indicating the invitee is declining the invitation;
associating a different invitee with the particular property; and
alerting the different invitee of the association with the particular property.

7. A method as defined in claim 6 wherein the invitations are modifiable by another invitee.

8. A computer readable storage medium having computer readable computer executable instructions for providing experiential information to a client, that when executed by a processor cause a computer to perform a method, comprising:
compiling experiential information relating to a plurality of objects associated with a service provider, wherein the objects are available to the client for reservation;
receiving a request for information relating to one or more objects;
determining that experiential information should be provided; and
delivering experiential information to the client.

9. The computer readable medium as defined in claim 8 wherein the client has made a reservation and wherein the experiential information is specific to the reserved object.

10. The computer readable medium as defined in claim 9 wherein the object comprises one of a hotel room, a cruise ship vacation, a restaurant table, or an invitation to an event.

11. The computer readable medium as defined in claim 8 further comprising:
receiving contact information from the client; and
establishing a two-way communication between the service provider and the client.

12. The computer readable medium as defined in claim 11 further comprising:
receiving updates from the client regarding the reservation; and
sending different experiential information to the client in response to receiving the updates from the client.

13. The computer readable medium as defined in claim 8 wherein the objects are invitations to events and the client is an invitee, wherein the method further comprises:
receiving an invite acceptance and contact information from the invitee;
associating the invitee with a particular property;
receiving an update from the invitee indicating the invitee is declining the invitation;
associating a different invitee with the particular property; and
alerting the different invitee.

14. A system for providing experiential information to a client, comprising:
at least one processing unit; and
at least one memory communicatively coupled to the at least one processing unit and storing instructions that, when executed by the at least one processing unit, cause the system to perform a method of automatically providing experiential information to a client, the method comprising:
compiling experiential information relating to a plurality of objects associated with a service provider, wherein the objects are available to a client for reservation;
receiving a request for information relating to one or more objects;
determining that experiential information should be provided; and
delivering experiential information to the client.

15. The system as defined in claim 14 wherein the client has made a reservation and wherein the experiential information is specific to the reserved object.

16. The system as defined in claim 12 wherein the object comprises one of a hotel room, a cruise ship vacation, a restaurant table, or an invitation to an event.

17. The system as defined in claim 14 further comprising:
receiving contact information from the client; and
establishing a two-way communication between the service provider and the client.

18. The system of claim 17 further comprising:
receiving updates from the client regarding the reservation; and
sending different experiential information to the client in response to receiving the updates from the client.

19. The system of claim 14 wherein the objects are invitations to events and the client is an invitee, wherein the method further comprises:
receiving an invite acceptance and contact information from the invitee;
associating the invitee with a particular property;
receiving an update from the invitee indicating the invitee is declining the invitation;
associating a different invitee with the particular property; and
alerting the different invitee.

20. A system as defined in claim 19 wherein the invitations are modifiable by another invitee.
